(19) United States
(12) Patent Application Publication
(10) Pub. No.: US 2012/0276434 A1
(43) Pub. Date: Nov. 1, 2012

(54) HIGHLY FLEXIBLE PRINTED ALKALINE BATTERIES BASED ON MESH EMBEDDED ELECTRODES

(75) Inventors: Abhinav M. Gaikwad, Borivali (W) (IN); Gregory Lewis Whiting, Mountain View, CA (US)

(73) Assignee: Palo Alto Research Center Incorporated, Palo Alto, CA (US)

(21) Appl. No.: 13/095,373

(22) Filed: Apr. 27, 2011

(51) Int. Cl. H01M 10/02; H01M 10/04; H01M 6/02; H01M 4/04

(52) U.S. Cl. 429/127; 29/623.1; 29/623.5; 29/623.2

(57) ABSTRACT

A flexible battery and a method to form the flexible battery include forming an anode by embedding an anode type electro-active material within a mesh material and associating an anode current collector with the anode. Similarly a cathode is formed by embedding a cathode type electro-active material within a mesh material and a cathode current collector is associated with the cathode. An electrolyte is located between the anode and cathode, and the arrangement is sealed.

### BACKGROUND

The present application is directed to batteries, and more particularly flexible batteries and the process for making such flexible batteries.

There is a great deal of interest in the development of folding, conformable electronic devices. It has been shown that flexible electronic devices would be useful for a wide range of functionality such as digital memory, photovoltaic cells, displays, pressure sensors, implantable medical devices, light emitting diodes, RFID tags, smart cards, self-powered portable devices, microelectronics, and thin film transistors, among others. However, it is also understood that such flexible electronic devices cannot reach their full realization until flexible batteries are developed that match device form-factor and power requirements of flexible electronic devices.

Flexible batteries share several manufacturing challenges with their application to flexible electronics, including the thermal budget imposed by plastic substrates, compatibility issues of different layers in the device and stability during bending. While there has been progress in these areas as applied to flexible electronics, a similar level of advancement has not been achieved in flexible batteries.

One approach to improve the mechanical stability of flexible electronics is the use of very thin electrodes and buckled electrode configuration, thereby reducing the strain on these structures during bending. Similar principles, however, are not as useful for flexible batteries because cell capacity of a battery is directly related to the amount of electro-active material present in the battery. Hence a relatively large footprint is required for a thin battery in order to achieve the same capacity as of a typical battery with thick-film electrodes.

A battery consists of current collectors, electrodes (e.g., anode, cathode), an electrolyte and an encapsulating or sealing medium. In existing flexible type batteries the current collectors and electrodes are formed as thin metallic foils, by the use of printed inks with a suitable polymeric binder or as vapor deposited layers. Thicknesses of such electrodes are limited to few tens (10 s) of microns to prevent cracking of the electrodes during flexing. Such thin film batteries have very low capacity. However, even with low thickness there is a limit of the flexibility and bend radius of such a battery. Metallic oxides in the configuration of thin foils, which form the active anode, are very brittle and crumble after few flexing cycles. A separator is generally used to ensure the dislodged particles do not come in contact with the other electrode. Thus existing flexible batteries are limited by the required tradeoff between battery capacity needs and the flexibility needs.

Therefore it is understood that improvements to overcome the limitations of existing flexible type batteries are considered a necessity for successful adoption of flexible electronic devices.

### BRIEF DESCRIPTION

A flexible battery and a method to form the flexible battery includes forming an anode by embedding an anode type electro-active material within a mesh material and associating an anode current collector with the anode. Similarly a cathode is formed by embedding a cathode type electro-active material within a mesh material and a cathode current collector is associated with the cathode. An electrolyte is located between the anode and cathode, and the arrangement is sealed.

### BRIEF DESCRIPTION OF THE DRAWINGS

FIG. 1 illustrates a mesh material;

FIG. 2 is a cross-sectional view of FIG. 1;

FIG. 3 is a flow diagram illustrating processing for the construction of an electrode according to the present concepts;

FIGS. 4A-4H are SEM generated images of elements of a flexible battery according to the present application;

FIG. 5 is a flow diagram for the formation of a flexible battery according to the present application;

FIG. 6 is an illustration of a sandwich battery arrangement;

FIG. 7 is an illustration of a parallel battery arrangement;

FIGS. 8A-8D are characterization charts for a battery configured according to the present application;

FIGS. 9A-9D are characterization charts for a battery configured according to the present application; and

FIGS. 10A-10B illustrate operation of batteries configured in accordance with the present application.

### DETAILED DESCRIPTION

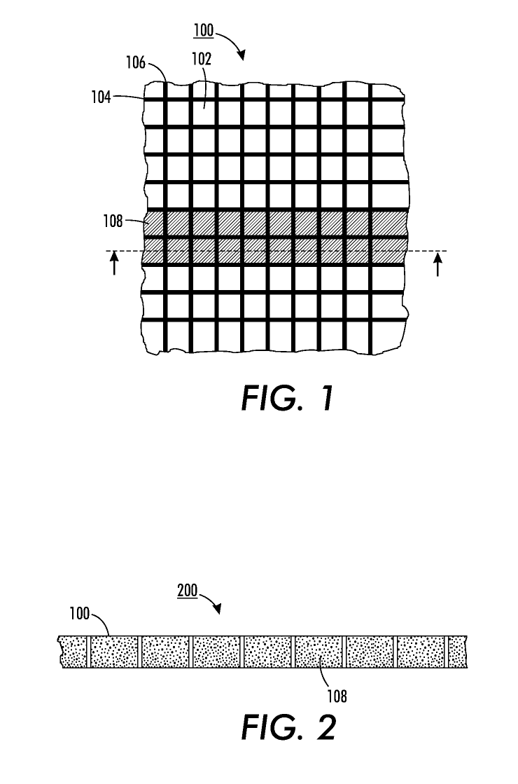

FIG. 1 illustrates a substrate in the form of a mesh material 100 having a plurality of voids 102 defined by horizontal lines or wires 104 and vertical lines or wires 106. An electrode of a flexible battery according to the present application is formed by filling voids 102 of mesh material 100 with an electro-active material 108 (for description purposes only some of the voids 102 are shown as having been filled in FIG. 1). FIG. 2 illustrates mesh material 100 in cross-section at voids 102 which have been filled by electro-active material 108, such as in the form of an ink slurry.

Mesh material 100 may be a conductive mesh or a non-conductive mesh, i.e., horizontal lines or wires 104 and vertical lines or wires 106 may be made of conductive or non-conductive material. A conductive mesh is configured of any appropriate conductive material including but not limited to stainless steel (SS), nickel, or silver, among others. The non-conductive mesh is configured of any appropriate non-conductive or insulating material including but not limited to nylon, polyester, polyethylene, or polypropylene, among others.

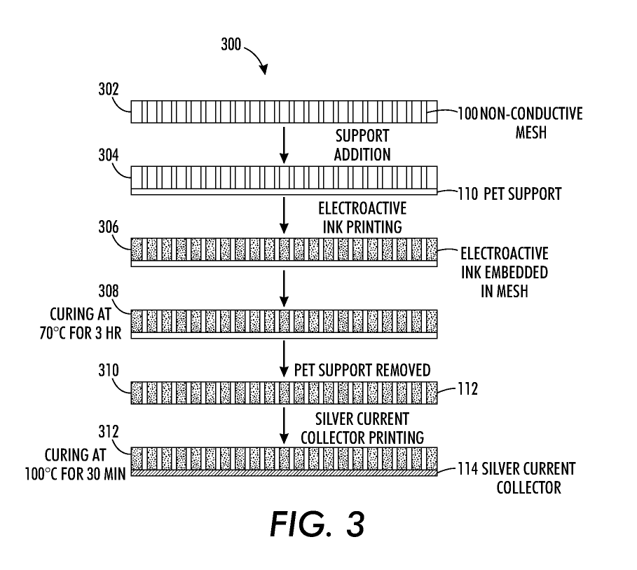

Turning to FIG. 3, depicted is a process flow 300 by which mesh 100 (in the form of a non-conductive mesh) is fabricated into a mesh embedded flexible electrode according to the present application.

Initially an appropriate mesh material 100 for a particular application is selected (Step 302). The size of the mesh or “mesh size” (defined as the number of voids or holes in a linear inch) selected can depend on a number of factors, including but not limited to the thickness of electrode required for a particular implementation, the particle size of an electro-active material to be used in the process, as well as the stress environment in which the battery will be used For example, for applications where the flexible battery will experience high stress a smaller mesh size may be used as opposed to a use when there will be less stress.

In one example a 50-mesh size nylon mesh is employed. After selection of mesh 100, a temporary backing or support member 110, such as a polyester sheet (e.g., polyethylene terephthalate (PET)) or other suitable material is attached to one side of the mesh (Step 304). Then electro-active material 108 is applied to the voids of the mesh (Step 306). In this example, application of the electro-active material 108 is accomplished by stencil printing the electro-active material to the mesh, although it is understood other application techniques can be used The support member 110 acts to maintain the electro-active material 108 within voids 102 of mesh 100. Next the electro-active material 108 embedded within the mesh is cured (Step 308). In one embodiment the curing is accomplished by placing the embedded mesh into an oven at 70° C. for three hours, to remove any residual solvent. After the curing process support member 110 is removed (Step 310), forming a flexible embedded mesh electrode 112. It is to be noted that while the above discusses a process which uses a support member, when certain techniques are employed to apply the electro-active material to the mesh material a support member may not be needed. In these situations therefore the process steps related to the support member may be avoided.

As a further processing step to prepare flexible electrode 112 for use as part of a flexible battery, process flow 300 includes applying a layer of conductive material 114 to a surface of flexible electrode 112, and then curing the conductive material (Step 312). In one particular embodiment Step 312, entails stencil printing a thin layer of flexible silver ink onto the underside of the mesh to form the current collector of the flexible battery. The silver current collector is cured in an oven at 100° C. for 30 minutes giving a surface resistivity of ˜0.015 Ω/m. It is to be understood the processing steps of FIG. 3 may be undertaken in sequences other than those set out above.

In the foregoing electrode forming process, it was mentioned that either a non-conductive mesh or a conductive mesh may be used. When a conductive mesh is used, it may act as the current collector as well as absorbing the stress during bending of the electrode. Therefore, when a conductive mesh is used Step 312 or a similar step may not be needed. Thus, current collectors are operatively associated with respective ones of the anode and cathode, by either forming a current collector layer when a non-conductive mesh is used or using the existing lines of a conductive mesh when a conductive mesh is employed.

Examples of materials that may comprise the electro-active material include but are not limited to Zinc (Zn) for formation of an anode electrode and Magnesium Dioxide (MnO₂) for formation of a cathode electrode. Each of these electro-active materials commonly being in an appropriate mount with an appropriate binder to form an slurry (e.g., an ink slurry) that is applied to the mesh.

As also mentioned above, and as will be expanded upon below, the electro-active material mixed with suitable binder is in one embodiment printed onto mesh 100, which will occupy voids 102. Common printing techniques like screen-printing, stencil printing, offset printing, roll-to-roll printing, dispenser printing, among other printing and non-printing application processes may be used.

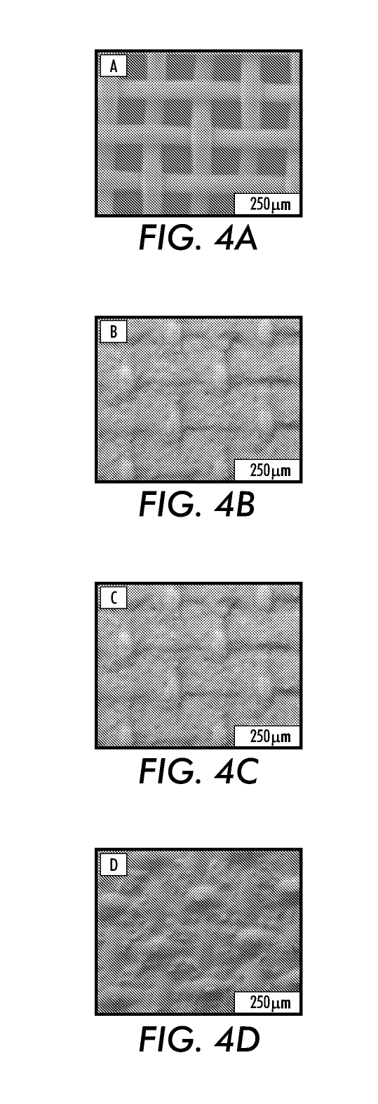

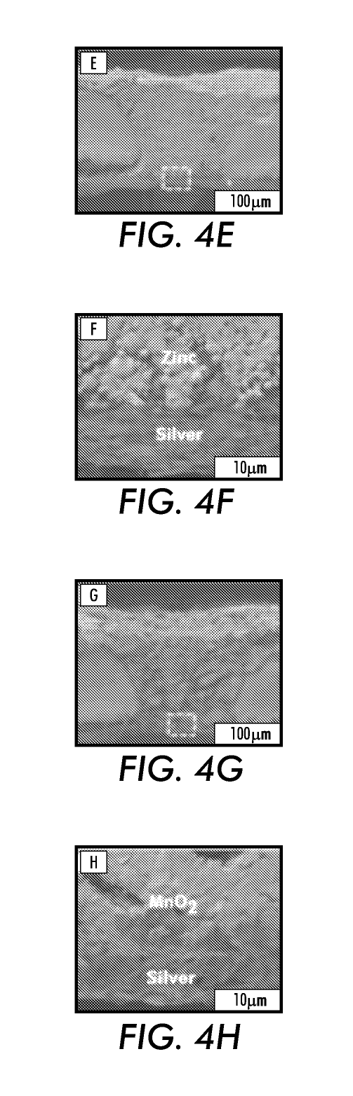

Turning now to FIGS. 4A-4H illustrated are scanning electron microscopy (SEM) generated images of results obtained by implementing the above processing steps of FIG. 3, when using a Zinc (Zn) electro-active based material and Magnesium Dioxide (MnO₂) electro-active material. FIGS. 4A-4D are topographic views. More particularly, FIG. 4A is a top surface SEM image of a 50-mesh sized nylon mesh such as used as the substrate for the flexible electrodes (it is understood that while only one mesh material is shown in these images, the Zn and MnO₂ electrodes use different meshes). FIG. 4B shows a top surface view of a mesh embedded Zn electrode, FIG. 4C shows a top surface view of a mesh embedded MnO₂ electrode, and FIG. 4D shows a top surface view of a silver current collector, as characterized by scanning electron microscopy (SEM).

FIGS. 4E-4H depicts SEM cross-section micrographs. More particularly, FIG. 4E is a cross-section SEM image of the Zn material embedded within the mesh, FIG. 4F is a cross-section image of the Zn-Silver interface within the mesh, FIG. 4G is a cross-section image of the MnO₂ material embedded within the mesh, and FIG. 4H is a cross-section image of the MnO₂-Silver interface within the mesh.

Both the topography and cross-section SEM analysis clearly show that the Zn and MnO₂ ink slurries substantially fill or occupy the void spaces in the mesh substrate after the printing process is complete. FIGS. 4F and 4H demonstrate that good electrical contact of Zn and MnO₂ with the silver current collector has been achieved. The cross-sectional views also teach that the material within the voids has a thickness substantially equal to the thickness of the lines or wires of the mesh. Wherein the thickness of the lines or wires in these figures are approximately 200 microns.

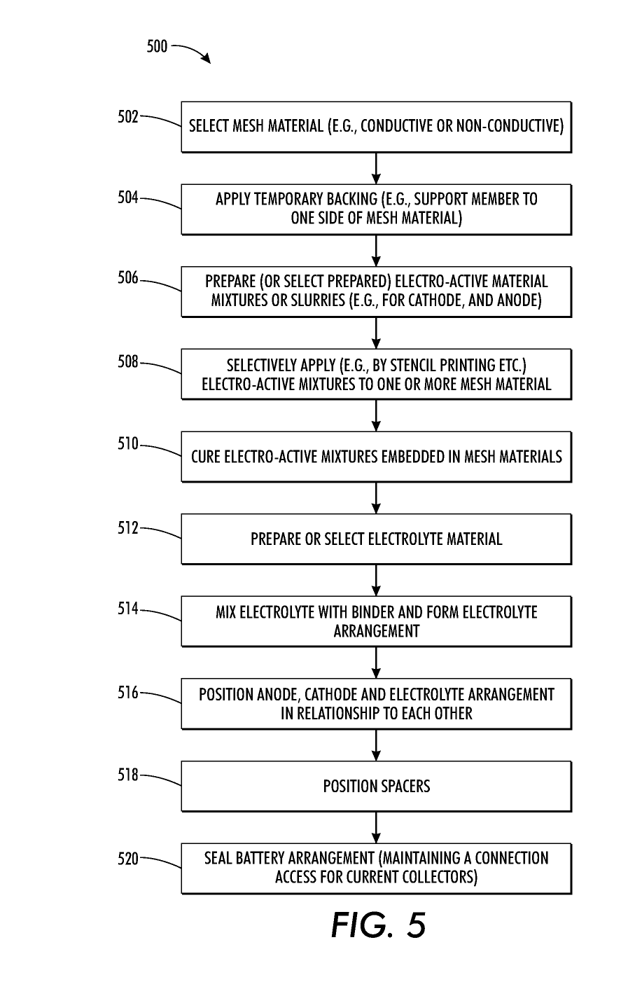

Turning now to the forming of a flexible battery, attention is directed to the flow diagram 500 of FIG. 5 which describes formation of a flexible battery using a conductive mesh material, according to the present application.

Initially a suitable conductive mesh material is selected (Step 502). This mesh material will need to be stable in the selected battery system and will not react with the electrolyte. On some embodiments this entails coating the conductive mesh with a protective material, one such coating operation being accomplished by electroplating the mesh material.

A support member, such as an insulating medium like polyethylene, polypropylene, etc is attached to one side of the mesh, to act as a casting for the battery (Step 504).

Electro-active slurries are selected and/or prepared. Where the slurries will have electro-active particles or ink (e.g., MnO₂, Zn, etc.) and a suitable binder (Step 506).

The slurry of electro-active ink and binder are selectively printed or otherwise applied to the mesh material using printing techniques like screen-printing, offset printing, roll-to-roll printing, dispenser printing, etc. (Step 508). As part of Step 508, it is understood, the mesh material will be printed with an electro-active material (e.g., Zn) to form the anode electrode and a separate portion of mesh material will be printed or have otherwise applied another electro-active material (e.g., MnO₂) to form the cathode electrode.

Next, the embedded mesh material with the anode electro-active material and the cathode electro-active material are cured to ensure any solvent is completely vaporized and to solidify the electro-active material within the respective mesh material (Step 510).

Next, an electrolyte material is formed or selected (Step 512). Examples of such an electrolyte material include but are not limited to suitable conductive salts KOH, NaOH, ZnCl2, NH4Cl2, etc.

An aqueous electrolyte material can be mixed with a polymeric binder to increase the viscosity of the electrolyte and prevent leakage (Step 514). Optionally the electrolyte may be applied to a portion of the conductive mesh, by printing etc., as done for example to form the anode and cathode electrodes described above. In this way the electrolyte material is embedded within a portion of its own mesh material. In other embodiments the electrolyte material is applied to a flat substrate sheet.

The anode and cathode are then positioned in either a parallel or sandwich type relationship to each other, with the electrolyte positioned there between (Step 516), and a spacer arrangement is provided to maintain a separation of the anode electrode and the cathode electrode (Step 518).

Lastly, the elements of the battery (e.g., anode, cathode, spacer arrangement, and current collectors) are sealed using a known sealing material and sealing technique (Step 520). It is understood that as part of the sealing operation some sort of access, such as would be know in the art is provided to allow an operative connection between the current collectors and an external connector. It is to be understood the processing steps of FIG. 5 may be undertaken in sequences other than those set out above.

As will be understood the flexible battery processing steps of FIG. 5 did not include the formation of a current collector as part of the anode and cathode electrodes as shown in FIG. 3. As mentioned in connection with FIG. 3, when the mesh material is a non-conductive mesh material such a current collector is formed by application of a conductive material such as flexible silver. However in the embodiment of FIG. 5, the lines of the mesh material itself are used as the current collector. By this design the conductive mesh is used as both the substrate for the electro-active material and as the current collector. Particularly, when a conductive mesh material is used, an external current connector would be attached to one or more of the mesh lines. On the other hand when a non-conductive mesh material is used the external connection is made to the formed current collector described in connection with FIG. 3.

Therefore, it is to be understood that a flexible battery which uses a non-conductive mesh material may be formed using the processing steps of FIG. 5, but when the non-conductive mesh is used such steps would also include generating the current collectors as described in connection with FIG. 3.

It is understood that in the foregoing examples, after the mesh material has been embedded (e.g., embedded with an electro-active material or electrolyte) it may be cut or otherwise formed into appropriate sizes that are used to assemble a flexible printed battery. Alternatively the mesh may be formed into the desired size and formed prior to the embedding. Further the formation of the electrodes may include filling selective voids of a single sheet of mesh, i.e., patterns corresponding to the particular implementation can be formed. Still further, different electro-active material may be put onto the same sheet of mesh material. The foregoing are examples of manufacturing options which exemplify the ease with which the present processing allows for customization

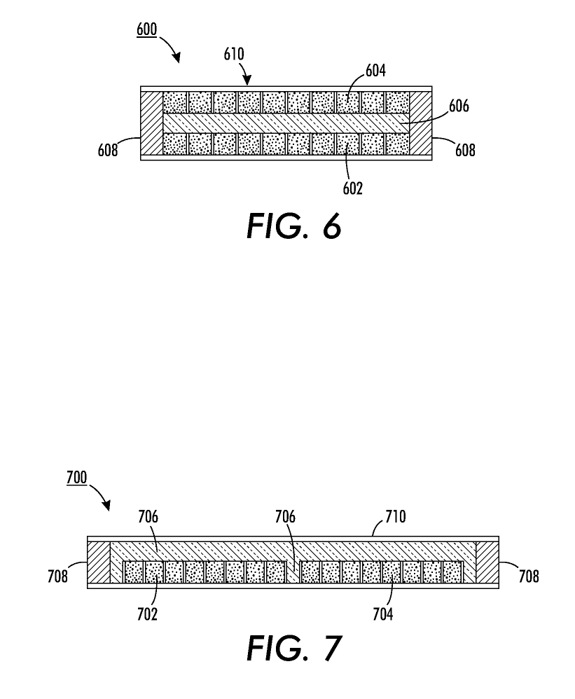

The components (e.g., anode, cathode, current collectors, electrolyte, and spacer arrangement) are then arranged into the desired flexible battery. For example as shown in FIG. 6 a sandwich-type battery arrangement 600 or as shown in FIG. 7 a parallel-type battery arrangement 700 may be formed. It is to be appreciated the described processing steps allow for easily customized battery manufacturing whereby flexible batteries of a large variety of shapes, sizes and operational characteristics are obtainable.

In the sandwich-type arrangement 600, individual components (anode 602, cathode 604, and electrolyte 606) are placed on top of each other, which contributes to a reduced overall footprint of the flexible battery. The components are maintained apart from each other by separator arrangement 606, and the overall configuration is then sealed and/or insulated by sealing or insulating material 610. Access areas (not shown) are provided in a known manner to permit connection between the current collectors and external connections.

In the parallel-type arrangement 700 of FIG. 7 the anode 702 and cathode 704 are placed side-by-side in parallel, with electrolyte 706 positioned between and on a side. Spacers 708 are used to maintain the components from each other, and the arrangement is then sealed or insulated by sealing or insulating cover 710. Again, access areas (not shown) are provided in a known manner to permit connection between the current collectors and external connections.

As mentioned previously, in printed batteries, the individual components (anode, cathode, current collector and the electrolyte) are in some embodiments deposited and patterned using printing techniques such as dispenser printing, screen printing, roll to roll printing and stencil printing. In the foregoing examples stencil printing may be used to deposit the electro-active material and optionally the electrolyte. However it is to be understood other application technologies to apply the electro-active material and electrolyte to mesh material may also be used.

Inks for the anode and cathode are generally in the form of slurries of electro-active material mixed with a binder and a suitable solvent. The ink rheology can be tailored by adjusting the concentration of the binder. The overall flexibility of the battery depends on the mechanical properties of each individual component: anode, cathode, electrolyte, substrate, spacers, and packaging.

In one embodiment a battery which has been formed using the described techniques with a non-conductive mesh material is a manganese dioxide (MnO₂)—Zinc (Zn) based primary alkaline battery. This type of battery has long dominated the market for primary battery use due to its high energy density, low internal resistance and relatively flat discharge. It is to be appreciated, however, that the present techniques are also appropriate for other battery systems such as those based on Zn-Silver Oxide and Lithium Ion, which are known to provide high energy density and potential. These techniques are also applicable to polymer gel electrolytes which have previously been used in batteries and capacitors due to their combination of mechanical stability, adjustable conductivity, and ease of packaging. It is therefore understood that the concepts described herein are applicable to a wide range of battery systems now in use and other yet to be developed systems.

The architecture described herein addresses the thickness and capacity limitations of thin film flexible batteries without compromising power performance of a traditional battery. The mesh structure acts as a support and reduces the stress on the electro-active material during mechanical flexing.

In the mesh embedded Zn—MnO₂ alkaline battery architecture to accommodate the mesh electrodes, Polyacrylic Acid (PAA) (with a Mol. Wt.=1,250,000) based alkaline polymer gel electrolyte (PGE) was used as the electrolyte, which was formed by dissolving PAA in aqueous Potassium Hydroxide (KOH) saturated with Zinc Oxide (ZnO). The current collector material should be highly flexible, have high conductivity and high crease resistance to ensure no ohmic losses during flexing. A flexible silver ink has been used herein as the current collector (in the non-conductive mesh example). In addition to the flexible silver, other materials that can be used include carbon and carbon nanotubes due to their high flexibility and conductivity, among others.

The starting point for the mesh embedded electrode, in one embodiment, was a non-conductive 50-mesh size nylon mesh. The aqueous inks for the anode and cathode were prepared by mixing the electro-active material, an additive, and binder. The anode ink was a mixture of Zn, ZnO, Bi₂O₃ and polyethylene oxide (20% PEO dissolved in DI water) binder. ZnO and Bi₂O₃ were used as an additive to prevent hydrogen formation by zinc dissolution. The cathode ink was a mixture of battery grade MnO₂, synthetic graphite powder, 10 M KOH and PEO binder.

More particularly in one specific embodiment the composition was (by weight)—anode: 73% Zn, 6% ZnO, 3% Bi2O3, 18% polyethylene oxide. Cathode: 68% MnO2, 6% graphite, 6% KOH, 20% PEO. The anode and cathode inks, being developed such that they are 20% PEO in water, were prepared using standard battery compositions. Silver ink (AG-800, Conductive Compounds, Inc.) was used as a current collector on the mesh embedded with Zn and MnO₂. Different concentrations (1-10 M) of KOH were prepared by dissolving KOH pellets in DI water. The solution was then stirred with ZnO until saturation with excess ZnO removed by filtration. The PGE was prepared by dissolving PAA in the aqueous electrolyte. The mixture was stirred until a homogenous gel was formed. 200-mesh size nylon mesh was used as a separator and the assembled battery was heat sealed inside a polyethylene pouch.

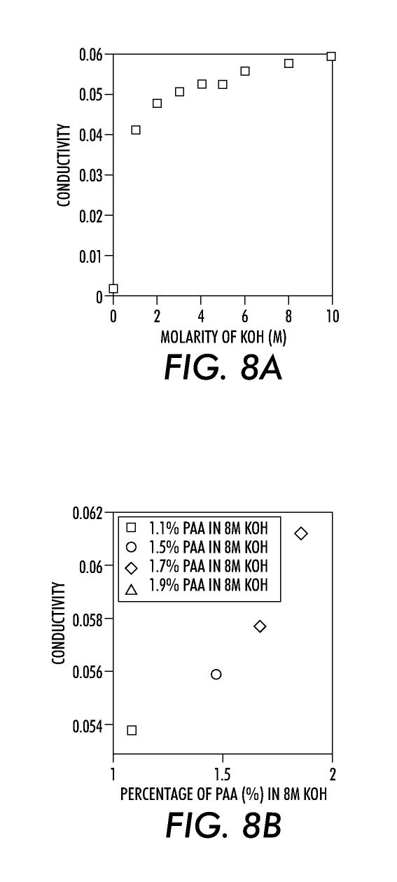

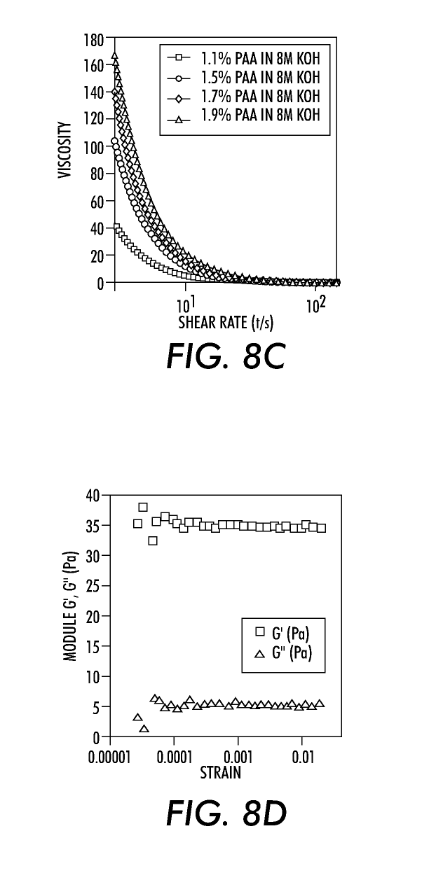

A contributing factor to the current a battery is able to source is the impedance of the electrolyte material used. The present disclosure has investigated electrolyte mixtures to improve the current output. In that regard, electrochemical impedance spectroscopy (EIS) was carried out to measure the effect of potassium hydroxide (KOH) and PAA concentration on the conductivity of the electrolyte gel. EIS experiments were carried out using a custom-made conductivity cell with stainless steel (SS) electrodes and a fluctuation voltage of 50 mV at frequency ranging from 10 Hz to 1000 kHz. The intercept on x-axis of the imaginary resistance (Z_{img}) versus real resistance (Zᵣₑₐₗ) plot was taken as the resistance (R_{elec}) of the electrolyte and was converted to conductivity (S/cm) by the formula (conductivity=thickness/(R_{elec}×area)). As shown in FIG. 8A the conductivity of the electrolyte gel rose steeply until 2M KOH concentration and then increased more slowly at higher concentration. FIG. 8B shows the effect of varying PAA concentration in the gel. Contrary to general observation, the conductivity of the PAA based PGE increased with increasing PAA concentration. This is due to high molecular weight (1,250,000) of PAA, which lead to a large increase in the aqueous electrolyte absorbed by the PAA based gel without a significant increase in the concentration of the non-conductive PAA.

Rheology experiments were carried out to study the effect of printing and flexing on the PGE. While the PGE is a highly viscous gel under no external stress, its viscosity decreases with shear rate (shear thinning), showing pseudo plastic behavior as seen in FIG. 8C. The high viscosity of the gel simplifies packaging and prevents leakages in cases when the cell is ruptured, and the shear thinning behavior of the PGE can be used advantageously to allow printing at lower pressure in large-scale manufacturing. The behavior of the PGE in the flexible battery during flexing to different bend radii was simulated by a strain sweep experiment, as shown in FIG. 8D. A strain sweep from 0.0001 to 0.02 at 1 Hz was applied to emulate the strain experienced by the PGE during flexing. G′ [elastic (storage) modulus] is indicative of gel like behavior and G″ [viscous (elastic) modulus] is indicative of liquid like behavior. The G′ and G″ values are almost constant in the strain sweep; indicating no degradation of the PGE is expected to take place during flexing of the battery. In our study the PGE was drop-cast on the electrode surface and a 200-mesh size nylon mesh was sandwiched between the two electrodes, which acts as the separator, giving an overall thickness of separator and PGE of 80 μm.

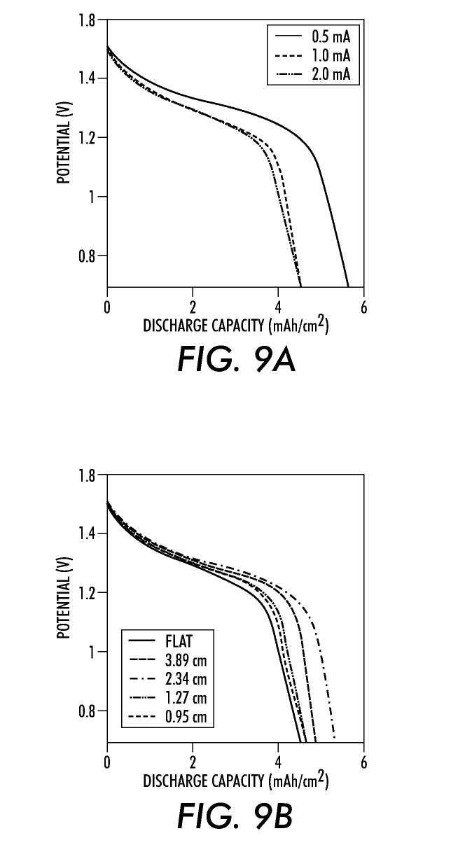

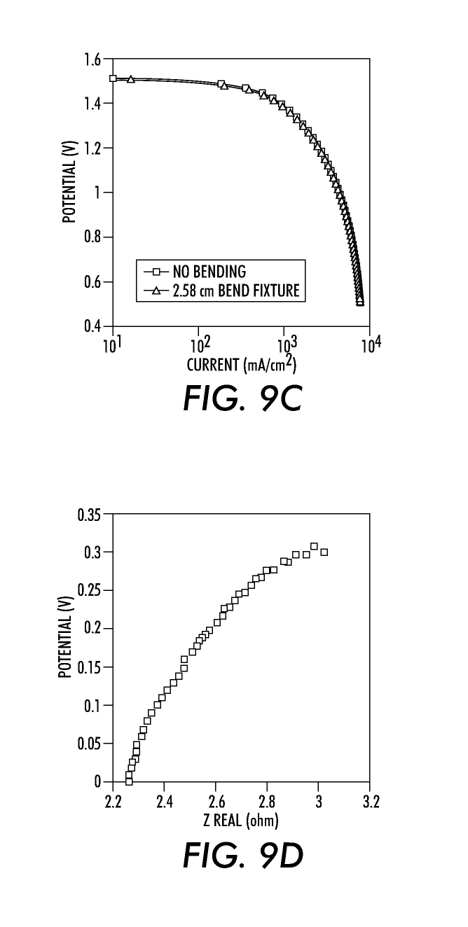

The discharge characteristics of the flexible battery are shown in FIG. 9A. The battery had a discharge capacity of 4.5 mAh/cm² at discharge rate of 1.0 and 2.0 mA, increasing to 5.6 mAh/cm² at a lower discharge rate of 0.5 mA. The performance of the battery during flexing was then characterized by bending the battery around various diameter cylinders during the discharge experiment, as shown in FIG. 9B. It is clear from this data that the battery showed no degradation in performance when flexed. In fact, the discharge performance of the battery was seen to improve after bending, due to compression of the battery, which leads better interfacial contact between the PGE and electrodes. FIG. 9C high current density of 51 and 53 mA/cm² was observed in a flat and a battery flexed to 2.54 cm bend radius respectively when polarized to 0.8 V. The high discharge current is useful for applications requiring large current for short time period. EIS experiments carried out on an unstrained battery show low impedance (FIG. 9D), thereby reducing ohmic losses during discharge. Power requirements for flexible electronic devices can range from high voltage, low amperage (e.g., organic TFTs) to relatively low voltage and high amperage (e.g., organic LEDs). As such it is important that the flexible battery design can be easily customized to provide the necessary power and energy requirements within the desired footprint.

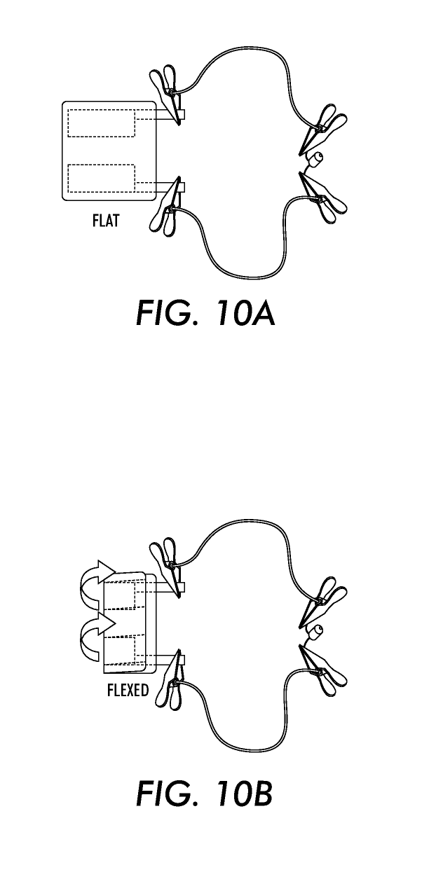

The ability to customize these batteries to operate devices is illustrated (FIG. 10A) for example by connecting two cells in series to power a green LED (operating voltage of 1.9 -2.4 V and current consumption from 4-32 mA). This battery is still able to power the LED even when folded over to a bend radius of 0.3 cm (FIG. 10B). Overall, a battery configured in accordance with the concepts disclosed herein provided a discharge capacity without any decrease in performance in bend conditions ranging from 3.81 cm to 0.95 cm. The flexible alkaline battery showed an open circuit potential of 1.52 V.

The EIS experiments were carried out using a 4192A LF impedance analyzer (HP) and a custom-made conductivity cell with SS electrodes. The area of the electrode was 3.95 cm² and the distance between the electrodes was 0.28 cm. SEM images of the battery components was taken using a JEOL 7400 SEM. The battery characterization experiments were carried out on PAR 263 poteniostat/galvanostat (Princeton Applied Research). Rheology of the PGE was studied using an AR 2000Ex rheometer (TA instruments) and electrical conductivity measurements were carried out using a four-point probe (M-700, Magne-Tron Instruments).

A particular aspect of the present disclosure is that of a flexible battery that has the ability to retain its flexibility while having a larger amount of electro-active material when compared to existing flexible batteries due at least in part to the use of the flexible mesh material. More particularly it has been determined that the presently disclosed processing steps are capable of forming flexible batteries that are capable of drawing 2 to 3 times the current for same sized currently existing flexible batteries, with approximately twice the flexibility of the currently existing flexible batteries.

It is mentioned here that while the forgoing examples have described the mesh material 100 as a substantially a wire/line frame type mesh, having substantially rectangularly defined voids, the present concepts are intended to cover embodiments implemented with mesh material having voids of different configurations such as mesh material with diamond, and circular voids, among others, where voids within the same mesh may be of different configurations. Also, the mesh material may be formed by variety of arrangements including the formation of intersecting metal and non-metal wires or lines. The mesh material of the present application is also defined to include substrates made by a cutting or stamping operation, such as the cutting or stamping of a planar metal or non-metal form, such as a metal or non-metal foil material, where the voids formed by the cutting or stamping, may be of a number of different configurations (e.g., diamond, or circular voids, etc.) such as those described above.

The described methods and devices present a new battery architecture which can be easily incorporated with present manufacturing techniques. The new architecture reduces problems faced in present flexible printed batteries like cracking and crumbing of the electrode on flexing of the electrode. The new battery architecture allows for less binder to be used, increasing the amount/thickness of the electrode leading to higher capacity without sacrificing flexibility. The new architecture improves flexibility of the battery and provides a significant improvement with respect to operating bend radius when compared to currently available flexible batteries. The support mesh structure absorbs stress generated during the bending of the electrode. The strength, flexibility and capacity of the electrode can be controlled with the mesh size and thickness. When a conductive mesh is used the conductive mesh can be used as a current collector, avoiding use of expensive inks (i.e. Silver) and reducing required printing steps. The mesh architecture is not limited to alkaline battery systems and could be used with other battery chemistries.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method of configuring a flexible battery comprising:
forming an anode by embedding an electro-active material within a mesh material;
associating an anode current collector with the anode;
forming a cathode by embedding an electro-active material within a mesh material;
associating a cathode current collector with the cathode;
forming a electrolyte; and
positioning the electrolyte between the anode and the cathode.

2. The method according to claim 1 further including positioning a spacer arrangement to separate the anode and the cathode.

3. The method according to claim 2 further including sealing the anode, the cathode, the anode current collector, the cathode current collector, and the spacer arrangement together by a sealing material.

4. The method according to claim 4 further including providing access through the sealing material.

5. The method of claim 1 wherein forming the electrolyte includes embedding an electrolyte material within a mesh material.

6. The method according to claim 1 wherein the mesh material of the anode and the cathode is a conductive mesh material.

7. The method according to claim 1 wherein the mesh material of the anode and the cathode is a non-conductive mesh material.

8. The method according to claim 1 wherein,
the forming of the anode layer by embedding the electro-active material includes applying a support material on a side of the mesh to hold the electro-active material within the mesh during the applying of the electro-active material to the mesh and curing the electro-active material within the mesh; and
the forming of the cathode by embedding the electro-active material includes applying a support material on a side of the mesh to hold the electro-active material within the mesh during the applying of the electro-active material to the mesh and curing the electro-active material within the mesh

9. A flexible battery comprising:
an anode including a mesh material with an embedded electro-active material;
an anode current collector operatively associated with the anode;
a cathode including a mesh material with an embedded electro-active material;
a cathode current collector operatively associated with the cathode; and
an electrolyte, wherein the electrolyte is positioned between the anode and the cathode.

10. The battery according to claim 9 further including a spacer arrangement arranged to separate the anode and the cathode.

11. The battery according to claim 10 further including a sealer material which seals the anode, the cathode, the anode current collector, the cathode current collector, and the spacer arrangement together by a sealing material.

12. The method according to claim 11 further including providing an access through the sealing material to permit connection of the battery to an external connection.

13. The battery according to claim 9 wherein the electrolyte is comprised of a mesh material carrying an embedded electrolyte material.

14. The battery according to claim 9 wherein the mesh material of the anode and the cathode is a conductive mesh material.

15. The battery according to claim 9 wherein the mesh material of the anode and the cathode is a non-conductive mesh material.

16. The battery according to claim 9 wherein the anode and cathode are arranged in a parallel relationship to each other.

17. The battery according to claim 9 wherein the anode and cathode are arranged in a sandwich type relationship to each other.

18. A method of configuring a flexible electrode:
selecting a mesh material, having a plurality of voids;
applying an electro-active material to the mesh material, causing the electro-active material to fill at least some of the voids of the mesh material; and
curing the electro-active material within at least some of the voids.

19. The method according to claim 18 wherein the mesh material is a conductive mesh material.

20. The method according to claim 18 wherein the mesh material a non-conductive mesh material.

21. A flexible electrode configuration comprising:
a mesh material having a plurality of voids; and
an electro-active material embedded within at least some of the voids.

22. The configuration according to claim 24 wherein the mesh material is a conductive mesh material.

23. The configuration according to claim 24 wherein the mesh material a non-conductive mesh material.
